(19) United States
(12) Patent Application Publication
(10) Pub. No.: US 2004/0074120 A1
(43) Pub. Date: Apr. 22, 2004

(54) Segmented display

(76) Inventors: Christopher James Newton Fryer, Cambridgeshire (GB); Christopher John Andrew Bernardo, London (GB)

Correspondence Address: Daniel J Warren, Sutherland Asbill & Brennan, 999 Peachtree Street N E, Atlanta, GA, 30309, US

(21) Appl. No.: 10/432,512

(22) PCT Filed: Nov. 21, 2001
(86) PCT No.: PCT/GB01/05127

(30) Foreign Application Priority Data
Nov. 21, 2000 (GB) 0028348.1

(51) Int. Cl. G09F 3/04

(52) U.S. Cl. 40/450

(57) ABSTRACT

A seven-segment display for displaying the digits 0 to 9 has a top segment (1), a middle segment (4), a bottom segment (7), left and right upper segments 2, 3 and left and right lower segments (5, 6). The bottom segment (7) is composed of a horizontal limb (7a) and a vertical limb (7b). The interface between the top segment (1) and the upper left segment (2) is substantially horizontal. The interfaces between the middle segment (4) and each of the adjacent vertical segments (2-6) are arcuate. The interfaces between the top and bottom segments (1, 7) and the adjacent right segments (3, 6) are vertical. The characterising features increase the clarity of the display without increasing the total number of segments.

The present invention relates to segmented displays, and in particular to electronic or electrical segmented displays.

A segmented display is a device comprising a plurality of independent segments arranged such that the device is capable of representing letters and/or numerals by activating, i.e. turning on, selected segments of the display. The segments may be activated electrically, for example illuminated, or mechanically, for example uncovered.

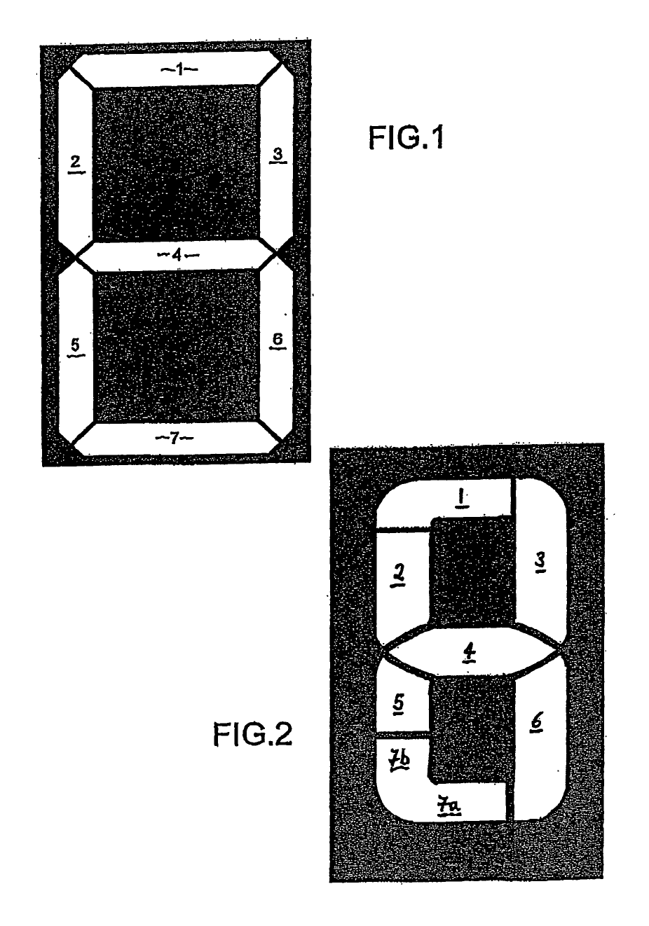

Segmented displays have been used for many years to represent numerals and letters. The original type of segmented display was the traditional seven-segment display, shown in FIG. 1. This display comprises seven segments which are activated in various combinations to display the Arabic numerals 0 to 9. Such displays are common in digital watches, alarm clocks, calculators and the like, where the segments are often light emitting diodes (LEDs) or elements of liquid crystal displays (LCDs). Mechanical seven-segment displays are also known, for example in petrol pumps and clocks.

The purpose of a segmented display is to communicate information. However, the traditional seven-segment display requires a stylised representation of the Arabic numerals to be used and this may be recognised less quickly than numerals represented by a more complex display structure, such as a dot matrix display. However, as the complexity of the display structure increases so does the number of connections that must be made to the display, because a respective electrical connection must be provided to supply electricity selectively to each segment of an electronic display. Even in a mechanical display, an activation mechanism is required for each segment.

It will be seen therefore that in the design of a segmented display it is often necessary to compromise the clarity of the display in order to provide a simple display structure or vice versa.

In view of the above, the present invention seeks to provide an improved segmented display.

Viewed from a first aspect, the invention provides a segmented display for representing the Arabic numerals 0 to 9, the display comprising a bottom segment having a horizontal limb and a vertical limb, the vertical limb extending in the vertical direction from the left end of the horizontal limb.

Thus, the invention provides a segmented display, such as a seven-segment display, in which the bottom segment is not simply linear, but is L-shaped. It has been found that a display which includes such a bottom segment is clearer to the user, particularly in the display of the numerals 3, 5 and 9. However, this increased clarity is achieved without increasing the total number of segments, so that the complexity of the display structure is not increased.

The extent of the vertical limb of the bottom segment need only be sufficient to achieve the increase in clarity, as described above. Thus, the vertical limb should extend a substantial distance in the vertical direction from the horizontal limb. In one arrangement, the display comprises a horizontal middle segment and the extent of the vertical limb of the bottom segment may be approximately one quarter, one third or one half of the distance between the middle segment and the horizontal limb of the bottom segment.

The display may comprise a vertical left segment which extends from the left end of the middle segment to the vertical limb of the bottom segment. The length of the left segment may be approximately one, two or three times that of the vertical limb of the bottom segment.

In general, the limbs of the bottom segment form a continuous segment.

The other segments of the display may be arranged in any suitable manner, for example in accordance with the traditional arrangement of a seven-segment display. Thus, the display may comprise, in addition to the bottom segment, a top segment, a middle segment, upper and lower left segments and upper and lower right segments.

In a preferred arrangement, the display comprises a top segment which extends horizontally at the top of the display and a left segment which extends vertically downward from the top segment on the left side of the display. Advantageously, the interface between the top segment and the left segment is substantially horizontal.

It has been found that a horizontal interface between the left segment and the top segment increases the clarity of the display, particularly in relation to the numerals 2, 3 and 7, because it allows the top segment to extend to the left edge of the display and to be of relatively uniform thickness even at the interface. In this way, the clarity of the display is improved without increasing the total number of segments.

This in itself is believed to be a novel arrangement and thus viewed from a second aspect the invention provides a segmented display for representing the Arabic numerals 0 to 9, the display comprising a top segment which extends horizontally at the top of the display and a left segment which extends vertically downward from the top segment on the left side of the display, wherein the interface between the top segment and the left segment is substantially horizontal.

In a particularly preferred arrangement, the display comprises a top segment which extends horizontally at the top of the display, a bottom segment which extends horizontally at the bottom of the display and one or more right segments which extend vertically at the right side of the display between the top segment and the bottom segment. Advantageously, the interface between the top segment and the right segment adjacent thereto is substantially vertical. Preferably, the interface between the bottom segment and the right segment adjacent thereto is also substantially vertical. More preferably, each substantially vertical interface is aligned substantially with the left edge of the right segment(s).

It has been found that vertical interfaces between the right segments and the top and bottom segments significantly increase the clarity of the display, particularly in relation to the numerals 1, 4 and 7, because the right segments can extend from the top edge to the bottom edge of the display and be of relatively uniform thickness even at the interface. In a further way, the clarity of the display is improved without increasing the total number of segments.

This in itself is believed to be a novel arrangement and thus viewed from a third aspect the invention provides a segmented display for representing the Arabic numerals 0 to 9, the display comprising a top segment which extends horizontally at the top of the display, a bottom segment which extends horizontally at the bottom of the display and one or more right segments which extend vertically at the right side of the display between the top segment and the bottom segment, wherein the interface between the top segment and the right segment adjacent thereto is substantially vertical, the interface between the bottom segment and the right segment adjacent thereto is substantially vertical and each said interface is aligned substantially with the left edge of the right segment(s).

A further preferred configuration of the display comprises a middle segment which extends horizontally across the display, and first and second vertical segments which extend vertically in opposite directions from an end of the middle segment. The interface between the first vertical segment and the middle segment is, advantageously, arcuate such that when the first vertical segment is inactive and the middle and second vertical segments are active, the middle and second vertical segments give the impression of a smooth transition from the middle segment to the second vertical segment.

Again, it has been found that an arcuate interface between the vertical segment and the middle segment noticeably increases the clarity of the display, particularly in relation to the numerals 2, 4, 5, 6 and 9, because the active middle and second vertical segments give the impression of a continuous stroke, as would be expected from a handwritten numeral to which the user is accustomed. By means of this configuration, the clarity of the display is further improved without increasing the total number of segments.

This in itself is believed to be a novel arrangement and thus viewed from a fourth aspect the invention provides a segmented display for representing the Arabic numerals 0 to 9, the display comprising a middle segment which extends horizontally across the display, and first and second vertical segments which extend vertically in opposite directions from an end of the middle segment, wherein the interface between the first vertical segment and the middle segment is arcuate such that when the first vertical segment is inactive and the middle and second vertical segments are active, the middle and second vertical segments give the impression of a smooth transition from the middle segment to the second vertical segment.

In embodiments of the invention, the interface between the second vertical segment and the middle segment may also be arcuate such that when the second vertical segment is inactive and the middle and first vertical segments are active, the middle and first vertical segments give the impression of a smooth transition from the middle segment to the first vertical segment. Similarly, arcuate interfaces may be provided at each end of the middle segment.

A segmented display device may comprise a plurality of segmented displays according to the invention in order to display a plurality of digits.

Herein, the term “vertical” is not used in a strict sense, but is intended to indicate the direction of the upward and downward strokes used in the formation of Arabic numerals, for example the direction of the downstroke used to form the numeral 1. Likewise, the term “horizontal”, is used to denote the direction of the strokes which run transverse to the “vertical” direction, such as the uppermost stroke of the numeral 7. The terms “left”, “right”, “top” and “bottom” should be construed accordingly. The term “middle” is used to refer to a position between the top and the bottom of the display, although not necessarily half way between. It is envisaged that the horizontal and vertical directions need not necessarily be mutually perpendicular, for example in the case of italic script.

The segments of the display may be formed by light emitting diodes (LEDs), by regions of liquid crystal in an LCD display or by any other suitable electrical means.

In a preferred arrangement the display is in the form of an electroluminescent display. According to this arrangement, a layer of electroluminescent material (for example zinc sulphide doped with manganese and microencapsulated in a dielectric material) is sandwiched between a first, transparent electrode (for example indium tin oxide (ITO) on a polyester or polyethylene terephthalate (PET) substrate) and a plurality of second electrodes each corresponding to a segment of the display. When an AC driving voltage is applied between the first electrode and a respective second electrode the electroluminescent material emits light and the corresponding segment is illuminated.

An embodiment of the invention will now be described by way of example only and with reference to the accompanying drawings, in which:

FIG. 1 is a schematic representation of a seven-segment display according to the prior art;

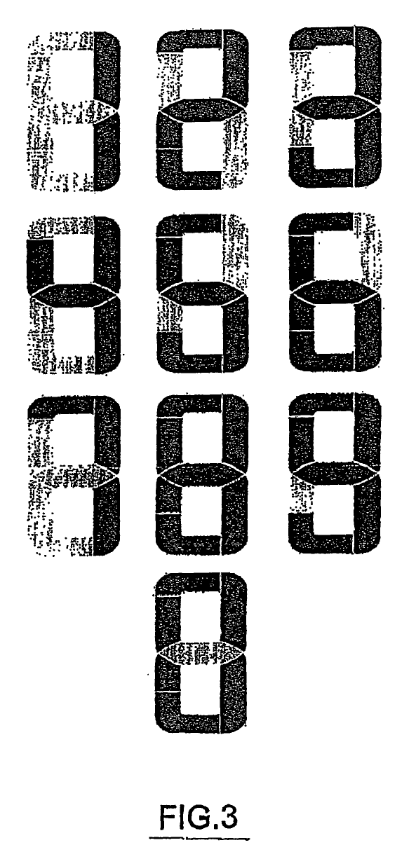

FIG. 2 is a schematic representation of a seven-segment display according to the invention; and

FIG. 3 shows the Arabic numerals 0 to 9 represented by the display of FIG. 2.

FIG. 1 shows a seven-segment display according to the prior art. This display has a top segment 1, a middle segment 4, a bottom segment 7, left and right upper segments 2, 3 and left and right lower segments 5, 6. The display of FIG. 1 is capable of displaying the digits 0 to 9 by selectively activating the segments 17, in a well-known manner.

FIG. 2 shows a seven-segment display according to the invention. The seven-segment display of FIG. 2 differs from the display of FIG. 1 as described below. Corresponding reference numerals are used in FIGS. 1 and 2 for corresponding segments of the display. FIG. 3 shows the Arabic numerals 0 to 9 represented by the display of FIG. 2.

In the display of FIG. 2, the bottom segment 7 is composed of a horizontal limb 7a and a vertical limb 7b, which gives the bottom segment 7 an L-shape. The lower left segment 5 is shortened to accommodate the vertical limb 7b of the bottom segment 7. As shown in FIG. 3, this feature allows the numerals 3, 5 and 9 to be provided with a more curved bottom stroke, which aids in their recognition by the user.

Furthermore, in the display of FIG. 2, the interface between the top segment 1 and the upper left segment 2 is substantially horizontal. As shown in FIG. 3, this feature allows the uppermost horizontal stroke of the numerals 2, 3, and 7 to be longer and thicker, which aids in the recognition of these numerals by the user.

Moreover, in the display of FIG. 2, the interfaces between the middle segment 4 and each of the upper left segment 2, the upper right segment 3, the lower left segment 5 and the lower right segment 6 are arcuate. As shown in FIG. 3, this feature allows the numerals 2, 4, 5, 6 and 9 to have a more naturally curved shape, which again aids in their recognition by the user.

Finally, in the display of FIG. 2, the interfaces between the top segment 1 and the upper right segment 3 and between the bottom segment 7 and the lower right segment 6 are vertical. As shown in FIG. 3, this feature allows the downstrokes of the numerals 1, 4, and 7 to be longer and thicker, which aids in the recognition of these numerals by the user.

Each of the distinguishing features of the display of FIG. 2 over that of FIG. 1 increases the clarity of the display without increasing the total number of segments, so that the electrical or mechanical complexity of the display is not increased.

The distinguishing features of the display described herein may be used in combination or singularly without departing from the scope of the invention.

The preferred arrangement of the display consists of seven segments, in order to minimise the total number of segments. It will be apparent to the skilled person, however, that displays having more segments may be created in accordance with the invention, if desired.

In summary, a seven-segment display for displaying the digits 0 to 9 has a top segment 1, a middle segment 4, a bottom segment 7, left and right upper segments 2, 3 and left and right lower segments 5, 6. The bottom segment 7 is composed of a horizontal limb 7a and a vertical limb 7b. The interface between the top segment 1 and the upper left segment 2 is substantially horizontal. The interfaces between the middle segment 4 and each of the adjacent vertical segments 2-6 are arcuate. The interfaces between the top and bottom segments 1, 7 and the adjacent right segments 3, 6 are vertical. The characterising features increase the clarity of the display without increasing the total number of segments.

1. A segmented display for representing the Arabic numerals 0 to 9, the display comprising a bottom segment having a horizontal limb and a vertical limb, the vertical limb extending in the vertical direction from the left end of the horizontal limb.

2. A segmented display as claimed in claim 1 further comprising a top segment which extends horizontally at the top of the display and a left segment which extends vertically downward from the top segment on the left side of the display, wherein the interface between the top segment and the left segment is substantially horizontal.

3. A segmented display for representing the Arabic numerals 0 to 9, the display comprising a top segment which extends horizontally at the top of the display and a left segment which extends vertically downward from the top segment on the left side of the display, wherein the interface between the top segment and the left segment is substantially horizontal.

4. A segmented display as claimed in any preceding claim comprising a top segment which extends horizontally at the top of the display, a bottom segment which extends horizontally at the bottom of the display and one or more right segments which extend vertically at the right side of the display between the top segment and the bottom segment, wherein the interface between the top segment and the right segment adjacent thereto is substantially vertical, the interface between the bottom segment and the right segment adjacent thereto is substantially vertical and each said interface is aligned substantially with the left edge of the right segment(s).

5. A segmented display for representing the Arabic numerals 0 to 9, the display comprising a top segment which extends horizontally at the top of the display, a bottom segment which extends horizontally at the bottom of the display and one or more right segments which extend vertically at the right side of the display between the top segment and the bottom segment, wherein the interface between the top segment and the right segment adjacent thereto is substantially vertical, the interface between the bottom segment and the right segment adjacent thereto is substantially vertical and each said interface is aligned substantially with the left edge of the right segment (9).

6. A segmented display as claimed in any preceding claim comprising a middle segment which extends horizontally across the display, and first and second vertical segments which extend vertically in opposite directions from an end of the middle segment, wherein the interface between the first vertical segment and the middle segment is arcuate such that when the first vertical segment is inactive and the middle and second vertical segments are active, the middle and second vertical segments give the impression of a smooth transition from the middle segment to the second vertical segment.

7. A segmented display for representing the Arabic numerals 0 to 9, the display comprising a middle segment which extends horizontally across the display, and first and second vertical segments which extend vertically in opposite directions from an end of the middle segment, wherein the interface between the first vertical segment and the middle segment is arcuate such that when the first vertical segment is inactive and the middle and second vertical segments are active, the middle and second vertical segments give the impression of a smooth transition from the middle segment to the second vertical segment.

8. A segmented display as claimed in claim 6 or 7, wherein the interface between the middle segment and each adjacent vertical segment is arcuate.

9. A segmented display as claimed in any preceding claim, wherein the display comprises a total of seven segments.

10. A segmented display as claimed in any preceding claim in the form of an electroluminescent display.

11. A segmented display substantially as represented in FIG. 2.

12. A segmented display device comprising a plurality of segmented displays according to any preceding claim.
